(19) United States
(12) Patent Application Publication
(10) Pub. No.: US 2012/0240543 A1
(43) Pub. Date: Sep. 27, 2012

(54) APPARATUS AND METHOD FOR EXTRACTING AQUATIC WEEDS

(76) Inventor: WALTER J. ANDREWS, LINDEN, CA (US)

(21) Appl. No.: 13/072,185

(22) Filed: Mar. 25, 2011

(51) Int. Cl. A01D 44/00

(52) U.S. Cl. 56/8

(57) ABSTRACT

An apparatus and method for removing rooted aquatic weeds. An elongated pole includes a remotely operated arm at its distal end. The arm is movable from a disengaged position to an engaged position. The user pushes the distal end of the pole underwater, until it enters the tendrils of a target weed. The remote control is activated, deploying the arm into an engaged position, generally perpendicular to the pole. Simultaneously, the user begins to rotate the pole until resistance to further rotation is detected. This indicates that the tendrils of the weed have been engaged by the arm. Pushing and pulling forces are applied to the pole, until the user detects that the roots of the weed have been extracted from the soil. Continued rotation of the pole while pulling upwardly brings the weed to the water surface, where it may be pulled completely out of the water.

### BACKGROUND OF THE INVENTION

1. Field of the Invention

The invention relates generally to improvements in extraction devices and methods for using same, designed specifically for removing aquatic weeds from waterways, and the like. More specifically, the invention pertains to an apparatus adapted to be immersed underwater having a portion on its distal end which is remotely deployable from a withdrawn position into an extended position for rotational entanglement with the target aquatic weed and removal of same by its roots.

2. Description of the Prior Art

U.S. Pat. No. 4,852,337, issued to Peterson, shows a method and an apparatus for removing aquatic plants from around docks and boating areas. The device employed is a rake with flexible teeth interconnected by a resilient strand of filament. A primary pull rope 28 and a back pull rope 30 are used to maneuver the rake into position, engage the plant, and then pull it out by its roots.

Another arrangement, designed for engaging underwater plants or roots for anchoring purposes, is shown in U.S. Pat. No. 2,983,243, granted to Bowers et al. This device relies upon a remotely controlled gripping hook to grasp onto an underwater portion of a plant or a root so that a small boat can be anchored in place.

A mechanical weed remover is disclosed in U.S. Pat. No. 4,547,010, issued to Camp. This device employs a length-adjustable pole, provided with a hand operated lever at one end, and pivotally actuated weed-gripping jaws on the other end. The two mechanisms are interconnected by a cable.

Another approach to removing weeds is illustrated in U.S. Pat. No. 2,025,254, granted to Stuart. This weeder has a sharp end 1, utilized in a first step to cut the weed. Then, the user employs a gripping and lifting blade B to effect the removal of the severed portion of the weed. A wire or cable may be used to interconnect the lever 13 with the blade B.

A weed extraction apparatus is shown in Patent Application Publication U.S. 2002/0073679, filed by Schench-Williams. A lever on the upper end of a bar is connected to a cable. The cable, in turn, is interconnected to two scissor-like claws. A pair of springs maintains the lever in a position normally perpendicular to the bar and the claws in a position normally open.

Yet another weeding tool is disclosed in U.S. Pat. No. 3,272,548, granted to Taylor. Normally closed, spring-loaded jaws are provided on the lower end of a tubular handle 12. A trigger 18 is provided on the handle's upper end. A rod 24 interconnects the trigger to the jaws. The trigger is used to open the jaws while the roots of the weed are dislodged by rotating and manipulating the jaws. Then, upon release of the trigger, the spring urges the jaws into a closed position, engaging the weed for withdrawal.

Nevertheless, there remains a need for a pole-like apparatus which has a proximate end above the water surface and a distal end which can be immersed underwater for engagement with otherwise unreachable, submersed portions of an aquatic plant or weed.

The need also exists for an underwater weeding apparatus employing weed engaging means on its distal end which can remotely be deployed by the user, from a withdrawn position to an extended position, to enhance its ability to become entangled with the weed. And, once the weed is so engaged, it can mechanically be removed by its roots and drawn to the water's surface by the device, through the application of pulling and agitating forces.

And, the need exists for an underwater weeding apparatus having the weed engaging means which can be manipulated from a withdrawn position to an extended position for weed extraction, and then from an extended position into a withdrawn position after the weed has been removed from the water, so the apparatus can be disengaged from the weed.

These and other objects of the apparatus and method of the present invention will be described in greater detail below.

### SUMMARY OF THE INVENTION

An apparatus and a method for removing rooted aquatic plants or weeds is disclosed. The apparatus comprises an elongated pole provided with a remotely operated arm, or other forms of weed engaging means, at its distal end. A lever is provided on the proximate end of the pole, having an operative interconnection to the arm. Remote control of the arm is thereby accomplished, providing selective movement of the arm from a withdrawn position to an extended position, generally perpendicular to the pole, and from an extended position to a withdrawn position, generally parallel to the pole.

With the weed engaging means in the withdrawn position, the user pushes the distal end of the pole underwater, until it enters the submersed tendrils of the targeted aquatic weed. The remote control lever is then activated, deploying the arm into an extended position, generally perpendicular to the pole. Simultaneously, the user begins to rotate the pole until resistance to further rotation is detected. This indicates that the tendrils of the weed have been engaged by the arm.

The user then applies pushing and pulling forces on the pole, until the roots of the weed are extracted from the soil. This is detected by the abrupt reduction of resistance to the pulling, and may sometimes be accompanied by bubbles making their way to the surface. These bubbles are caused by the release of oxygen, when the roots of the weed are removed from the underwater soil.

Continued rotation of the pole while pulling upwardly maintains the entire weed under control while it is brought to the surface of the water. At that point the weed may be pulled completely out of the water, and placed on the dock or the shore. Lastly, the weed engaging means is moved into a withdrawn position, so the pole can easily be removed from the weed tendrils.

### BRIEF DESCRIPTION OF THE DRAWINGS

FIG. 1 is a perspective view of the apparatus for extracting weeds, with the weed engaging means in a withdrawn position;

FIG. 2 is a view as in FIG. 1, but with the weed engaging means in an extended position;

FIG. 3 is a fragmentary perspective view of the median portion of the pole, showing the length adjustability feature and the locking pin;

FIG. 4 is a fragmentary perspective view of the remote control lever, showing both the unlocked position and the locked position in broken line;

FIG. 5 is a fragmentary, perspective view of one embodiment of the weed engaging means located on the distal end of the pole, the withdrawn and extended positions being shown in broken line;

FIG. 6 is a cross-sectional view taken on the line 6-6, in FIG. 5;

FIG. 7 is a perspective view showing the apparatus being rotated, with its weed engaging means in an extended position for engaging the underwater tendrils of an aquatic plant;

FIG. 8 is a fragmentary perspective view of the aquatic weed after the apparatus has been rotated to engage the tendrils;

FIG. 9 is a view as in FIG. 8, but showing pulling and pushing forces being alternatively applied to the apparatus and upon the aquatic weed;

FIG. 10 is a view as in FIG. 9, but showing the oxygen bubbles being released as the weed's roots are extracted from the soil;

FIG. 11 is a perspective view showing the aquatic weed being lifted vertically out of the water, after the roots have been pulled free from the soil;

FIG. 12 is a perspective view showing the extracted aquatic weed being pulled onto a dock;

FIG. 13 is a perspective view showing the apparatus being withdrawn from the weed tendrils, after the weed engaging means has been moved into a withdrawn position;

FIG. 14 is a fragmentary, cross-sectional view of an alternative construction for the weed engaging means, showing the arms in a withdrawn position;

FIG. 15 is a fragmentary, cross-sectional view of the lever mechanism shown at the upper end of FIG. 14;

FIG. 16 is a fragmentary, cross-sectional view of the weed engaging means shown in FIG. 14, but with the arms in an extended position;

FIG. 17 is a cross-sectional view as in FIG. 15, but with the lever mechanism rotated into lower position; and,

FIG. 18 is a fragmentary perspective view of yet another embodiment for the weed engaging means, employing a switch, a battery, and an electrical solenoid having a normally extended position.

### DETAILED DESCRIPTION OF THE PREFERRED EMBODIMENT

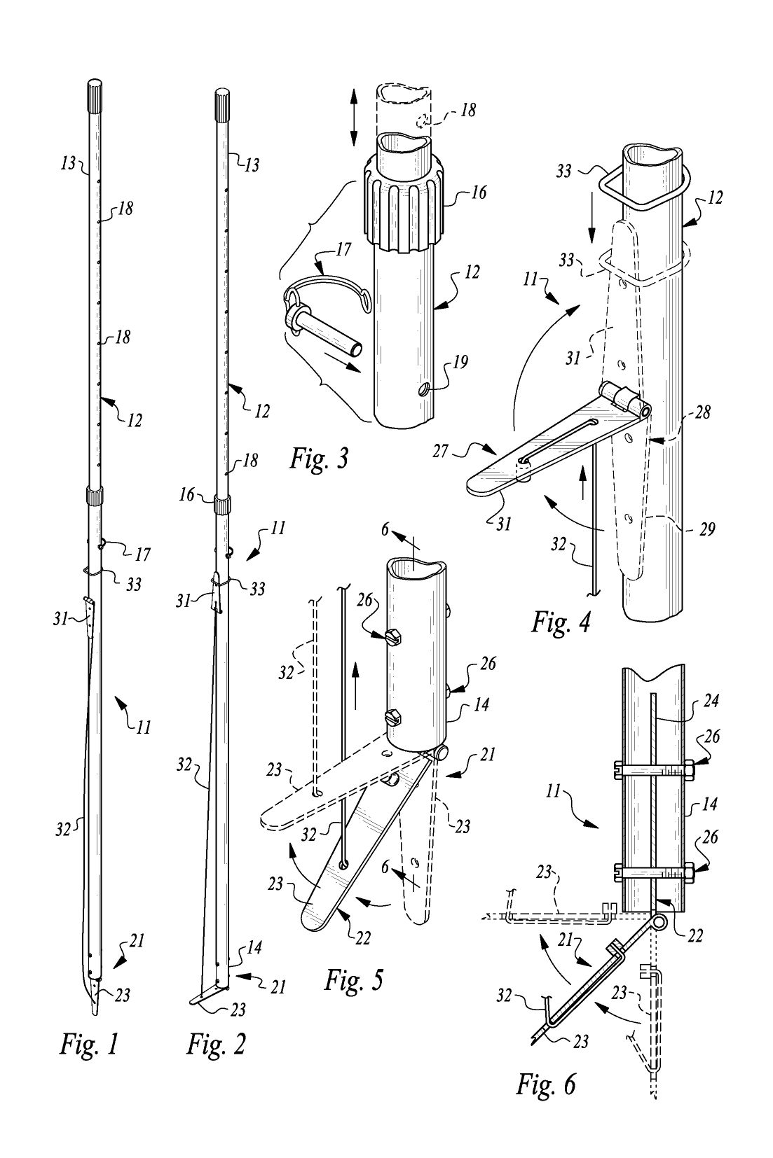

Making particular reference to FIG. 1, an apparatus 11 for the removal of a aquatic weeds is shown. Apparatus 11 comprises an elongated pole 12, having a proximate end 13 and a distal end 14. Pole 12 preferably has telescoping capabilities, so it can easily be adjusted in length for the job at hand For that purpose, a knurled locking ring 16 is provided to apply compressive forces to the juncture between the upper and lower segments of the pole 12, at the appropriate time. For additional securing, a locking pin 17 is also provided, once a selected aperture 18 in the upper pole segment becomes aligned with the pin bore 19 in the lower pole segment. (See, FIG. 3).

Weed engaging means 21 is mounted on the distal end 14, with a first construction thereof being shown most clearly in FIGS. 5 and 6. This first construction of weed engaging means 21 comprises a hinge 22, having an elongated arm 23 as one side thereof. Arm 23 is movable from a withdrawn position, in which the axis of arm 23 is generally parallel to or coincident with the axis of pole 12, to an extended position in which the axis of arm 23 is generally perpendicular to the axis of pole 12. The other side 24 of hinge 22 extends into and is mounted within distal end 14 by means of nut and bolt assemblies 26. It is apparent that arm 23 could also be pivotally mounted directly upon distal end 14, thereby eliminating the need for hinge 22.

To effect the desired movement of arm 23, remote control means 27 is provided. In one embodiment, remote control means 27 comprises a hinge 28, having a fixed portion 29 attached to the side of pole 12, intermediate proximate end 13 distal end 14. Hinge 28 also includes a movable handle portion 31, shown most clearly in FIG. 4. Handle portion 31 has an adjacent end pivotally mounted on the pole 12 by means of the pivot in hinge 28, and a remote end for grasping by the user. Handle portion 31 is also mechanically interconnected to arm 23 by a cable 32. As shown in FIG. 1, when handle portion 31 is in a released position cable 32 is generally slack, allowing arm 23 to assume a withdrawn position. However, when handle portion 31 is raised upwardly into a locked position, the cable 32 raises arm 23 upwardly into an extended position. (See, FIG. 2).

A keeper 33 is provided to maintain handle portion 31 against the pole 12, in its locked position. Keeper 33 is preferably made from a piece of semi-rigid wire, formed into a loop generally conforming to the circumferential configuration of the pole but including a flat corresponding to portion 31. (See, FIG. 4). The dimensions of keeper 33 are such that it can be slipped down and snugly over the handle portion 31 in its locked position, but can also be raised upwardly to release portion 31 when desired.

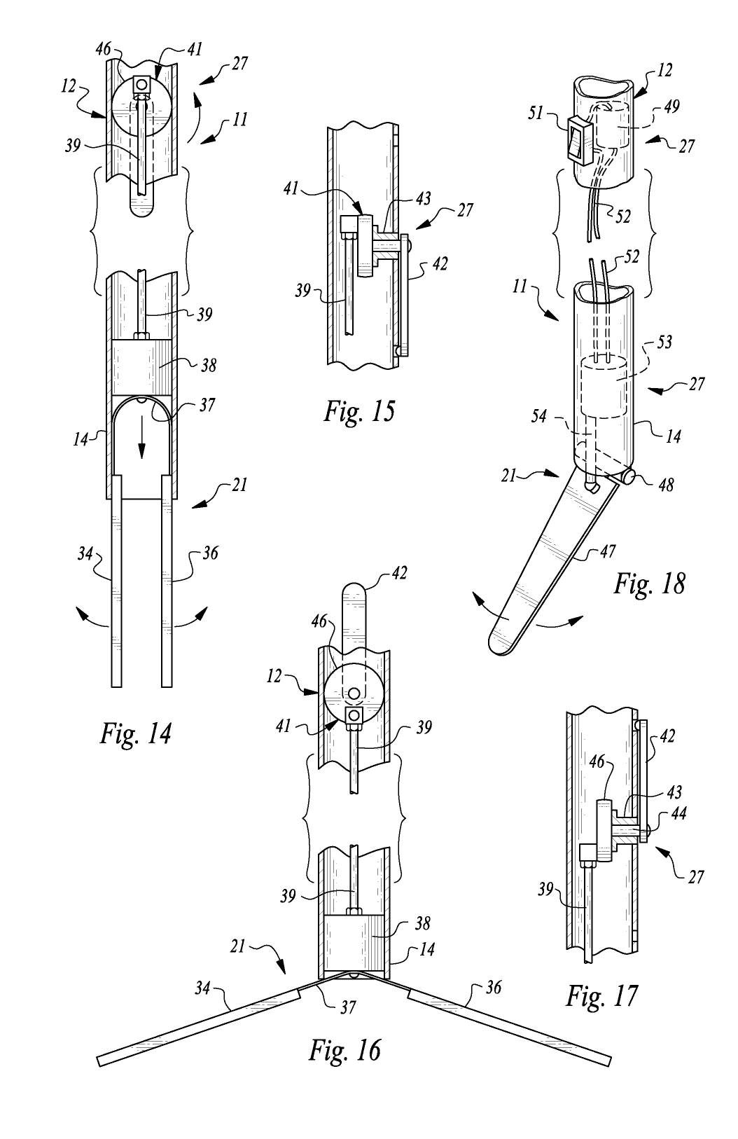

An alternative embodiment of weed engaging means 21 and remote control means 27 are illustrated in FIGS. 14-17. In this arrangement, weed engaging means 21 comprises a first arm 34, a second arm 36, and a strip 37 therebetween. Arms 34 and 36 are generally the same size as arm 23, discussed above, but must have a transverse dimension such that the two arms can be withdrawn and fitted within pole 12, as shown in FIG. 14. In this configuration, weed engaging means is in a withdrawn position. Strip 37 is made from a piece of resilient, flexible material, such as spring metal or plastic. A cylindrical connector plug 38 has a lower end connected to a median portion of strip 37, and an upper end connected to a rod 39.

Rod 39 extends through pole 12 until it reaches rotatable lever assembly 41. Rod 39 and lever assembly 41 comprise an alternative embodiment for remote control means 27. Lever assembly 41 includes a lever 42, a bearing 43, a shaft 44, and a disc 46. As shown in FIGS. 14 and 16, the upper end of rod 39 is eccentrically mounted upon the peripheral portion of disc 46. When lever 42 is pointed downwardly, as shown in FIG. 15, rod 39 is in a fully raised position, drawing up connector plug 38. Strip 37 is also drawn upwardly, folding first arm 34 and second arm 36 into generally parallel relation, with their upper ends nested within distal end 14 of pole 12.

When lever 42 is rotated 180° so it is pointed upwardly, as shown in FIGS. 16 and 17, rod 39 is in a fully lowered position, driving connection plug 38 downwardly. As strip 37 emerges from distal end 14, its spring action deploys arms 34 and 36 outwardly from respective sides of pole 12. In this configuration, weed engaging means 21 is in an extended position. It is apparent that more arms and strips could readily be added to the connection plug, to provide multiple sets of arms. It is also apparent that spring loaded wires, or other deployable structures, could be substituted for the arms, providing an equivalent function and result.

FIG. 18 depicts an additional embodiment for weed engaging means 21 and remote control means 27. As to weed engaging means 21, this additional embodiment comprises arm 47 mounted to distal end 14 by means of pivot 48. In FIG. 18, arm 47 is shown in a position intermediate its withdrawn position, where it is axially aligned with pole 12, and its extended position, where it is perpendicular to the axis of pole 12. The alternative embodiment for remote control means 27 is generally comprises electro-mechanical elements, namely, battery 49, switch 51, power leads 52, and solenoid 53. An actuator shaft 54 extends from the lower end of solenoid 53 and interconnects to one side of arm 47. Shaft 54 is pivotally connected at both ends, to allow shaft 54 to withdraw and extend without binding as arm 47 is moved from one position to the other.

Solenoid 53 is spring-loaded internally, to have a normally extended position when it is de-energized. Thus, with no electrical current passing through solenoid 53, shaft 54 will be extended, placing arm 47 into a withdrawn position. However, when switch 51 is moved into its on position, electrical current will pass from battery 49, through power leads 52, to actuate solenoid 53. Shaft 54 will then be withdrawn, which will pivot arm 47 outwardly into an extended position.

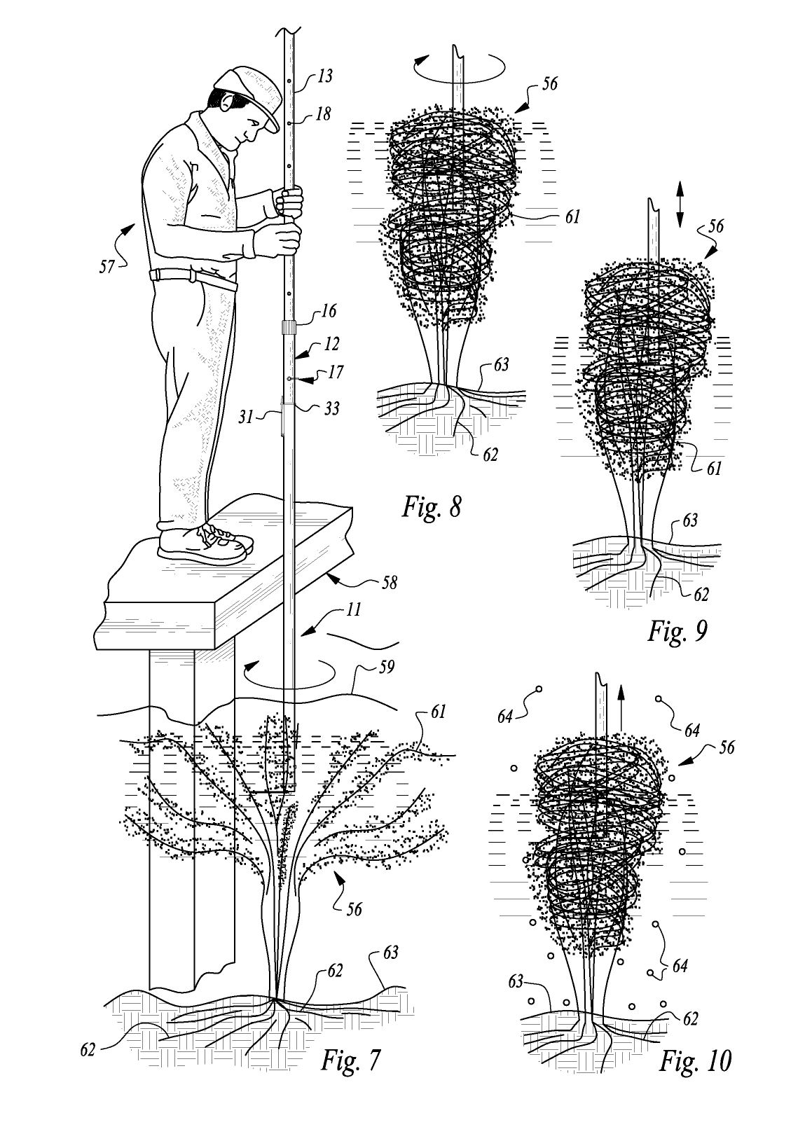

The method of extracting an aquatic weed 56, particularly using the apparatus 11 described above, is shown in FIGS. 7-13, inclusive. Typically, the target aquatic weed 56 to be extracted will be an invasive, non-native species, such as egeria densa. However, the apparatus and method disclosed herein can be used advantageously to remove any aquatic weed, irrespective of whether it is invasive, non-native, or rooted. Egeria densa and similar weeds or plants are particularly troublesome, because they grow rapidly, are not controlled through natural means, and can actually spread through harvesting. In other words, if only the tops of such weeds are removed, the plant will continue to grow from the remaining root portion, and regenerate. Also, fragments of harvested plants can continue to grow, re-root, and spread into new locations. When waterways become filled with this species, boating operations are impaired as propellers become entangled in the weeds. Slips in boat docks may be clogged with weed material, making vessel docking and departure operations more difficult.

Thus, the user 57, standing on a dock 58, begins the operation by grasping the pole 12 and pushing its distal end 14 below the surface of the water 59, toward the top of a target aquatic weed 56. At this juncture, the distal end 14 of the pole 12 is located either in or adjacent the submersed tendrils 61 of the targeted aquatic weed 56, while the proximate end 13 of the pole 12 remains above the surface of the water 59 in the hands of the user 57.

The user 57 then deploys the weed engaging means 21, by actuating remote control means 27 thereby moving weed engaging means 21 from a withdrawn position to an extended position. Depending upon the density of the weed, it may also be desirable to deploy the weed engaging means 21 before the distal end 14 is completely engaged with the weed tendrils 61. The more dense the weed material, the more desirable it will be to delay this step, until the distal end 14 is at least partially within the mass of the tendrils 61.

As the pole 12 sinks farther into the weed 56, the pole 12 is rotated, either clockwise or counter-clockwise, so that the weed engaging means 21 more fully engages and becomes entangled with the weed tendrils 61. The user 57 will feel resistance to further rotation, when the weed 56 has been fully engaged and wound up by the apparatus 11. (See, FIG. 8). It has also been observed that the cable 32 also becomes entangled with the tendrils 61, assisting in this operation.

Pulling forces are then applied to the pole 12, and those forces are directly transferred to the body of the weed and its roots 62, still secured in the soil 63. If forces which are either abrupt or too great are applied, the tendrils may break, thereby losing the opportunity to remove the entire weed 56. Downward pushing forces may also be applied to the pole 12, alternating with the pulling forces, to urge the roots 62 from their hold on the soil 63. (See, FIG. 9).

By observing the surface of the water 59, the user 57 may see oxygen bubbles 64 which have been released from the soil 63 as the roots 62 are extracted. (See, FIG. 10). This is a good sign that the roots 62 are in the process of being released by the soil 63. At the same time, the user 57 will feel a lessening to pulling resistance, as the roots 62 give way. Through continuing rotation of the pole 12, while straight up pulling forces are applied, the entire weed 56 will be maintained under control while it is brought to the surface of the water 59. This rotation of the weed 56 will also help to cleanse a certain amount of mud off the roots 62, making removal of the weed 56 from the water an easier process.

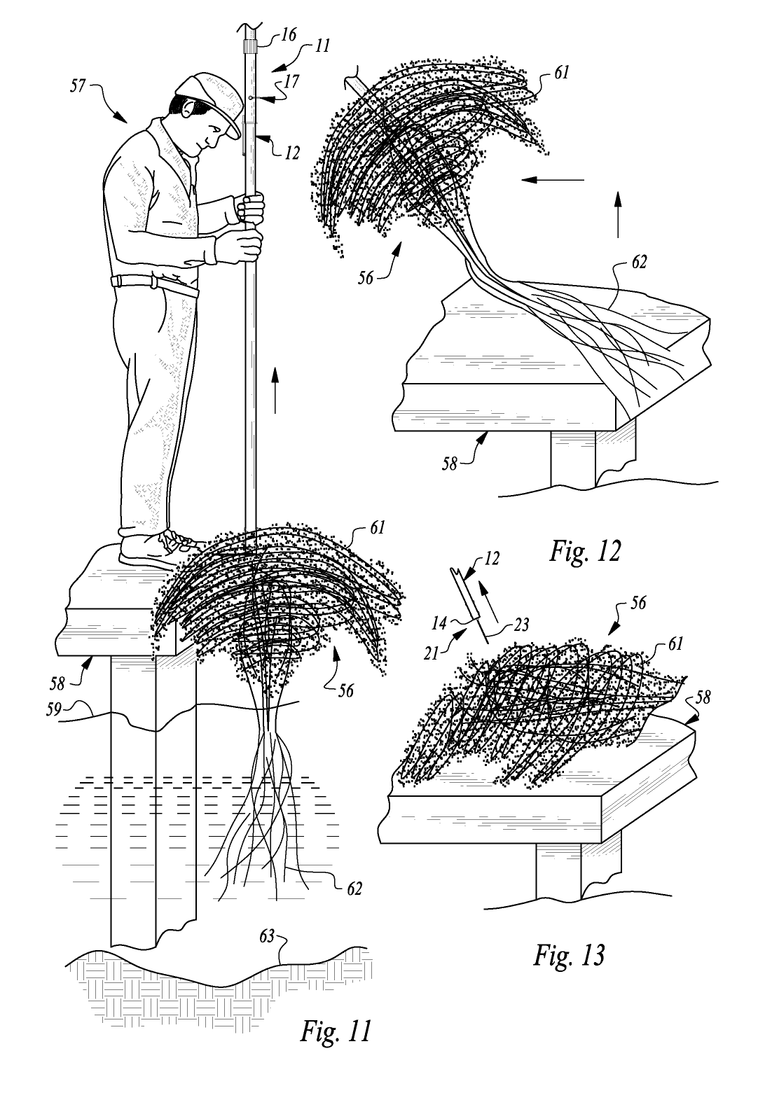

FIG. 11 shows the weed 56 being removed from the water, with all tendrils 61 and roots 62 intact. Typically, the weed 56 is dragged onto the dock 58, and laid out for drying. As a final step, shown in FIG. 13, the user 57 again employs the remote control means 27, to move the weed engaging means 21 into a withdrawn position. This facilitates the easy removal of the apparatus 11 from the main body of the weed 56.

1. An apparatus for the removal of an aquatic weed, comprising:
a. an elongated pole, said pole having a proximate end and a hollow, open distal end;
b. an elongated arm located on said distal end of said pole, said arm having a portion within said hollow open end and being movable from a withdrawn position generally parallel to said pole to an extended position generally perpendicular said pole; and,
c. remote control means on said pole intermediate said proximate end and said distal end, for moving said arm from said withdrawn position to said extended position for engaging an underwater portion of the weed, said remote control means comprising a handle, said handle being mounted on said pole and being mechanically interconnected to said arm by a cable, said handle having a released position placing said arm into said withdrawn position, and a locked position placing and maintaining said arm in said extended position.

2. An apparatus as in claim 1 in which said elongated arm has one end pivotally attached to said portion within said distal end.

3. An apparatus as in claim 1 in which said remote control means comprises a handle, said handle being mounted on said pole and being mechanically interconnected to said arm by a cable, said handle having a released position placing said arm into said withdrawn position, and a locked position placing said arm into said extended position.

4. An apparatus as in claim 1 in which said handle has an adjacent end pivotally mounted on said pole and a remote end for grasping by the user.

5. An apparatus as in claim 4 in which said remote end is maintained against said pole, when said handle is in said locked position.

6. An apparatus as in claim 5 comprising a loop extending circumferentially around said pole and having a diameter slightly larger than said pole, for sliding over said remote end of said handle in said locked position.

7. An apparatus as in claim 1 in which said arm comprises a first hinge.

8. An apparatus as in claim 7 in which said handle comprises a second hinge, and in which one side of said second hinge is attached to said pole.

9. An apparatus as in claim 1 in which said remote control means additionally moves said arm from said extended position to said withdrawn position for disengaging the engaged portion of the aquatic weed.

10. An apparatus for the removal of an aquatic weed, comprising:
a. an elongated pole, said pole having a proximate end and a hollow, open distal end;
b. weed engaging means mounted on and having a portion thereof extending within said hollow open end of said distal end, said weed engaging means having a withdrawn position disengaged from the plant and an extended position engaged with a portion of the plant; and,
c. a remote control mounted on said pole intermediate said proximate end and said distal end, said remote control having a released position and a locked position and being interconnected to said weed engaging means for selectively moving said weed engaging means from said withdrawn position to said extended position and from said extended position to said withdrawn position, whereby said remote control first moves and maintains said weed engaging means in an extended position to engage the underwater portion of the weed for removal from the water, and then releases said weed engaging means so that it assumes said withdrawn position and is disengaged from the removed weed.

11. An apparatus as in claim 10 in which said weed engaging means comprises an arm, said arm having one end pivotally attached to said portion extending within said distal end of said pole.

12. An apparatus as in claim 11 in which said arm further comprises a hinge.

13. An apparatus as in claim 11 in which said remote control comprises a hinge and a cable, one side of said hinge being attached to said pole and said cable being interconnected between the other side of said hinge and said weed engaging means.

14. An apparatus as in claim 10 in which said weed engaging means comprises a first arm and a second arm interconnected by a strip of resilient, flexible material, a median portion of said strip being interconnected to said remote control and extending within said distal end.

15. An apparatus as in claim 10 in which said remote control comprises an electrical switch, a source of electrical power, and an electrical solenoid, said solenoid having a normally extended position when it is de-energized, an actuator shaft of said solenoid being connected to said weed engaging means.

16. A method for the removal of an aquatic weed having submersed tendrils and roots, comprising the steps of:
a. providing an elongated pole, said pole having a proximate end and a hollow, open distal end, said pole being provided with weed engaging means on said distal end of said pole, said weed engaging means having a portion thereof extending within said hollow open end of said distal end; said weed engaging means being remotely controlled from said proximate end of said pole and having an arm movable from a withdrawn position adjacent said pole to an extended and maintained position remote from said pole;
b. pushing said distal end of said pole below the surface of the water, until said distal end is located either in or adjacent the submersed tendrils of the targeted aquatic weed, while said proximate end remains above the surface of the water;
c. remotely actuating said weed engaging means from said proximate end of said pole, into an extended and maintained position;
d. rotating said pole until resistance to further rotation is detected, and the tendrils of the weed have been engaged by said arm of said weed engaging means;
e. applying pulling forces on said pole, until the roots of the weed are extracted from the soil and the weed is removed from the water.

17. The method of claim 16, in which the order of steps b and c is reversed.

18. The method of claim 16, including the further step of detecting bubbles when said pulling forces are applied, as an indication that the roots of the weed have been extracted from the soil.

19. The method of claim 16, including the further step of continuing rotation of the pole while said pulling forces are applied, to maintain the entire weed under control while it is brought to the surface of the water.

20. The method of claim 16, including the further step of moving said arm of said weed engaging means into said withdrawn position after the weed is removed from the water, so said pole can easily be removed from the weed tendrils.
